(19) United States
(12) Patent Application Publication
(10) Pub. No.: US 2026/0122562 A1
(43) Pub. Date: Apr. 30, 2026

(54) SUPPORTING INCOMPATIBLE STAS DURING AP DYNAMIC POWER SAVE OPERATION

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Bilal Sadiq, Plano, TX (US); Peshal Nayak, Plano, TX (US); Rubayet Shafin, Frisco, TX (US); Yue Qi, Plano, TX (US)

(21) Appl. No.: 19/348,695

(22) Filed: Oct. 2, 2025

Related U.S. Application Data
(60) Provisional application No. 63/714,579, filed on Oct. 31, 2024.
(60) Provisional application No. 63/782,969, filed on Apr. 3, 2025.
(60) Provisional application No. 63/813,288, filed on May 28, 2025.

(51) Int. Cl. H04W 52/02; H04W 8/24

(52) U.S. Cl. CPC H04W 52/0206; H04W 8/24

(57) ABSTRACT

Methods and apparatuses for supporting incompatible stations (STAs) during an access point (AP) dynamic power save operation. A method of wireless communication performed by an AP includes determining a compatibility of a first station (STA) associated with the AP for a dynamic power save (DPS) mode; and performing an enablement operation associated with enablement of the DPS mode based on the determined compatibility of the first STA for the DPS mode.

### CROSS-REFERENCE TO RELATED APPLICATION(S) AND CLAIM OF PRIORITY

This application claims priority under 35 U.S.C. § 119(e) to U.S. Provisional Patent Application No. 63/714,579, filed on Oct. 31, 2024, U.S. Provisional Patent Application 63/782,969, filed on Apr. 3, 2025, and U.S. Provisional Patent Application 63/813,288, filed on May 28, 2025, each of which are hereby incorporated by reference in its entirety.

### TECHNICAL FIELD

This disclosure relates generally to wireless communication, and more specifically to supporting incompatible stations (STAs) during access point (AP) dynamic power save operation.

### BACKGROUND

Wireless Local Area Network (WLAN) technology allows devices to access the internet in the 2.4 GHz, 5GHz, 6GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for supporting incompatible STAs during AP dynamic power save operation.

In one embodiment, a method of wireless communication performed by an access point (AP) includes determining a compatibility of a first station (STA) associated with the AP for a dynamic power save (DPS) mode; and performing an enablement operation associated with enablement of the DPS mode based on the determined compatibility of the first STA for the DPS mode.

In another embodiment, an AP comprises a transceiver, and a processor operably coupled with the processor. The processor is configured to determine a compatibility of a first STA associated with the AP for a DPS mode; and perform an enablement operation associated with enablement of the DPS mode based on the determined compatibility of the first STA for the DPS mode.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of an operating mode notification frame format according to embodiments of the present disclosure;

FIG. 5 illustrates an example of an operating mode A-control field format according to embodiments of the present disclosure;

FIG. 6 illustrates an example of an extremely high throughput (EHT) operation element that is transmitted by an EHT AP according to embodiments of the present disclosure;

FIG. 7 illustrates an example of an EHT capabilities element transmitted by an EHT STA according to embodiments of the present disclosure;

FIG. 8 illustrates an example of DPS operation of an AP during an uplink transmission according to embodiments of the present disclosure;

FIG. 9 illustrates an example of a scenario of an AP enabling DPS mode with several associated STAs according to embodiments of the present disclosure;

FIG. 10 illustrates an example of an ultra-high reliability (UHR) capabilities element indicating a STA's ability to support DPS operation or assist DPS operation at a peer STA according to embodiments of the present disclosure;

FIG. 11 illustrates an example of an AP removing incompatible STAs before transitioning to the low power state according to embodiments of the present disclosure;

FIG. 12 illustrates an example of an AP providing an indication of reduced capabilities for sufficient time before transitioning to the low power state according to embodiments of the present disclosure;

FIG. 13 illustrates an example of a DPS wrapper element which can hold one or more previous generation elements according to embodiments of the present disclosure;

FIG. 14 illustrates an example of an AP removing incompatible STAs before disabling the DPS mode according to embodiments of the present disclosure;

FIG. 15 illustrates an example of an AP providing an indication of return to full capabilities for sufficient time after transitioning to the full capability state according to embodiments of the present disclosure;

FIG. 16 illustrates an example method performed by an AP for supporting incompatible STAs during DPS operation according to embodiments of the present disclosure;

FIG. 17 illustrates an example method performed by a DPS incompatible STA during DPS operation according to embodiments of the present disclosure; and

FIG. 18 illustrates another example method performed by an AP in a wireless communication system for supporting incompatible STAs during DPS operation according to embodiments of the present disclosure.

### DETAILED DESCRIPTION

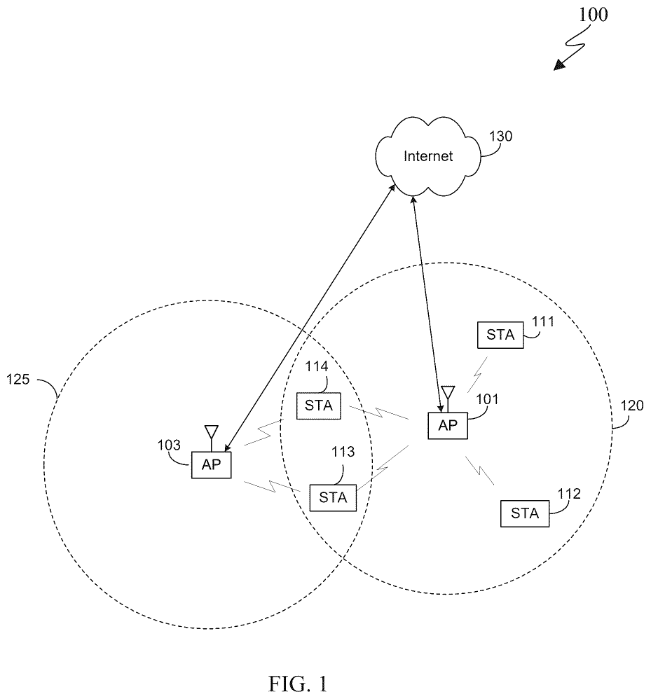

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification”; [2] IEEE P802.11ax/D8.0; [3] IEEE P802.11be/D5.0.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating supporting incompatible STAs during AP dynamic power save operation. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

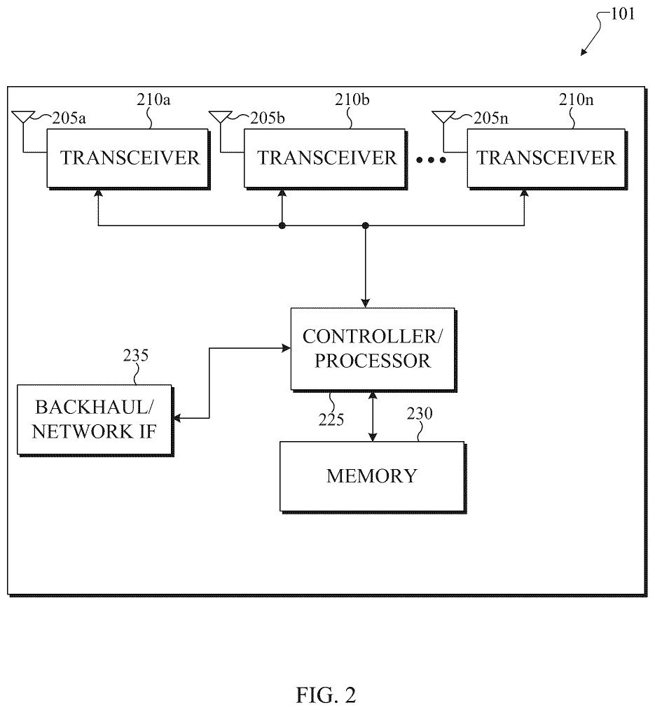

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating supporting incompatible STAs during AP dynamic power save operation. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating supporting incompatible STAs during AP dynamic power save operation. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in other APs. Also, various components in FIG. 2 could be combined, further subdivided, or omitted, and additional components could be added according to particular needs.

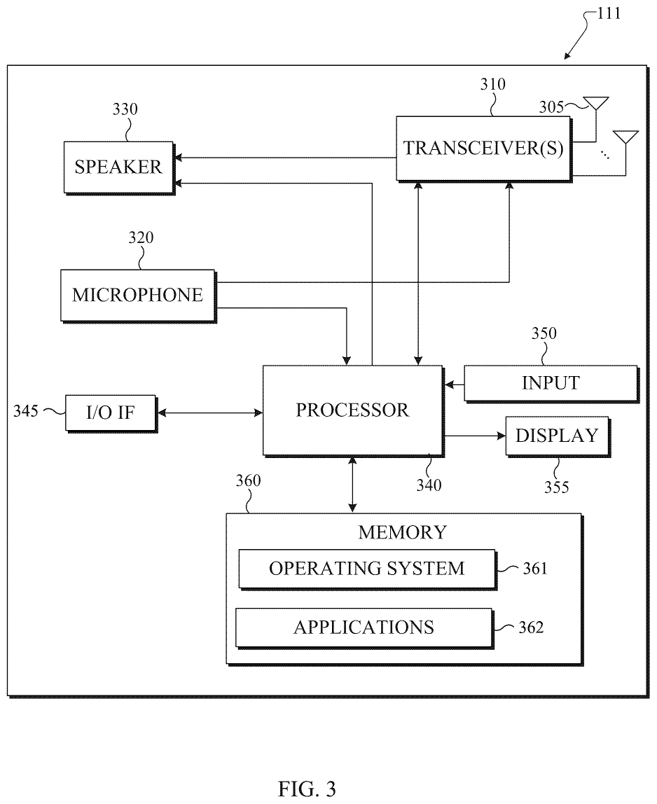

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate supporting incompatible STAs during AP dynamic power save operation. In some embodiments, the processor 340 includes at least one microprocessor or microcontroller.

The processor 340 is also capable of executing other processes and programs resident in the memory 360, such as operations for facilitating supporting incompatible STAs during AP dynamic power save operation. The processor 340 can move data into or out of the memory 360 as required by an executing process. In some embodiments, the processor 340 is configured to execute a plurality of applications 362, such as applications for facilitating supporting incompatible STAs during AP dynamic power save operation. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

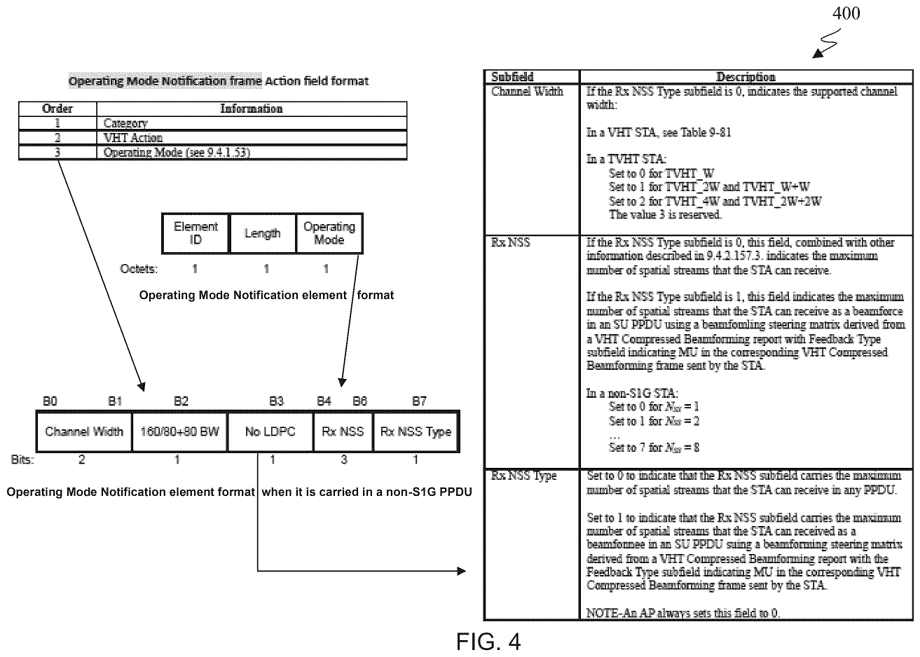

FIG. 4 illustrates an example of an operating mode notification frame format 400 according to embodiments of the present disclosure. The embodiment of the example operating mode notification frame format 400 shown in FIG. 4 is for illustration only. Other embodiments of the example operating mode notification frame format 400 could be used without departing from the scope of this disclosure.

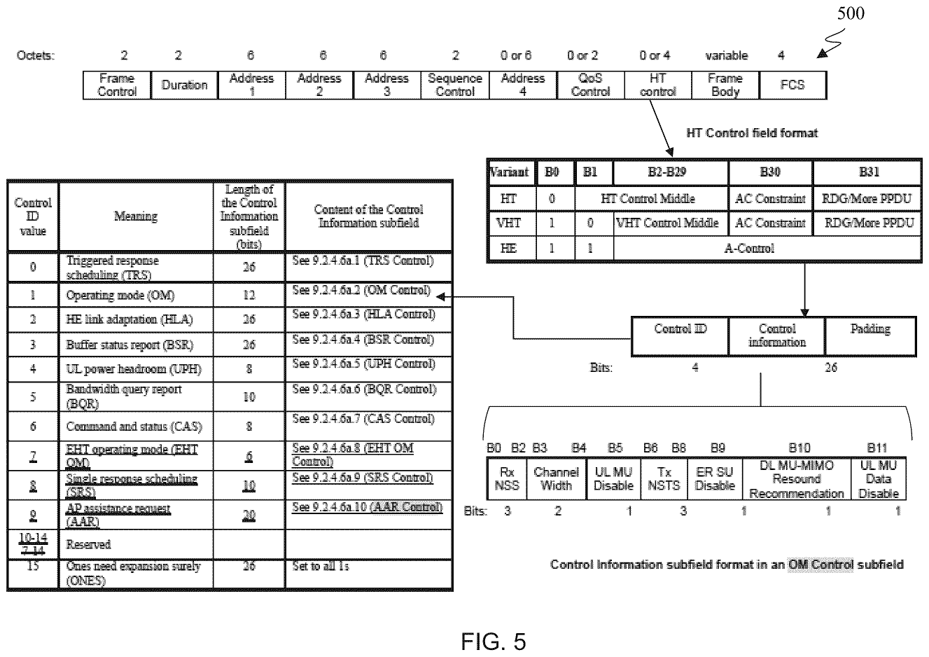

FIG. 5 illustrates an example of an operating mode A-control field format 500 according to embodiments of the present disclosure. The embodiment of the example operating mode A-control field format 500 shown in FIG. 5 is for illustration only. Other embodiments of the example operating mode A-control field format 500 could be used without departing from the scope of this disclosure.

To provide power saving mechanisms for APs (and also for STAs) that are operating in an awake state, the 802.11 2020 draft [1] defines a power saving mechanism called “operating mode change”. By using an operating mode change, a STA can change its operating channel width (CW) and/or the maximum number of spatial streams (NSS) that it can support. Thus, it can save power by reducing channel width or number of spatial streams when required. An AP or non-AP STA can change its RX operating mode by either:
Transmitting an Operating Mode Notification frame, which is a Very High Throughput (VHT) Action frame (class 3 management).
Transmitting an Operating Mode Notification element inside a beacon frame, (Re)association request/response frames.
Transmitting an Operating Mode (OM) Control subfield or EHT OM Control subfield in an A-control field of a Quality of service (QoS) Data, QoS Null or Class 3 Management frames.

A non-AP STA can change its TX operating mode by either:
Transmitting an OM Control subfield or EHT OM Control subfield in an A-control field of a QoS Data, QoS Null or Class 3 Management frames.

For any Modulation and Coding Scheme (MCS), the maximum receive NSS that a STA can support is equal to the smaller of:
The value of the “Rx Max Nss That Supports Specified MCS” subfield for the given EHT-MCS indicated in the Supported EHT-MCS and NSS Set.
The maximum supported NSS as indicated by the value of the Rx NSS field of the Operating Mode Notification frame or the Operating Mode Notification element if the value of Rx NSS Type is 0, or by the value of the Rx NSS field of the OM Control subfield if EHT OM Control subfield is not present in the same A-Control field, or by the value of the Rx NSS Extension field of the EHT OM Control subfield combined with the value of the Rx NSS field of the OM Control subfield.

For any MCS, the maximum transmit NSS that an STA can support is equal to the smaller of:
The value of the “Tx Max Nss That Supports Specified MCS” subfield for the given EHT-MCS indicated in the Supported EHT-MCS and NSS Set.
The maximum supported NSS as indicated by the value of the Tx NSTS field of the OM Control subfield if EHT OM Control subfield is not present in the same A-Control field, or by the value of the Tx NSS Extension field of the EHT OM Control subfield combined with the value of the Tx NSS field of the OM Control subfield.

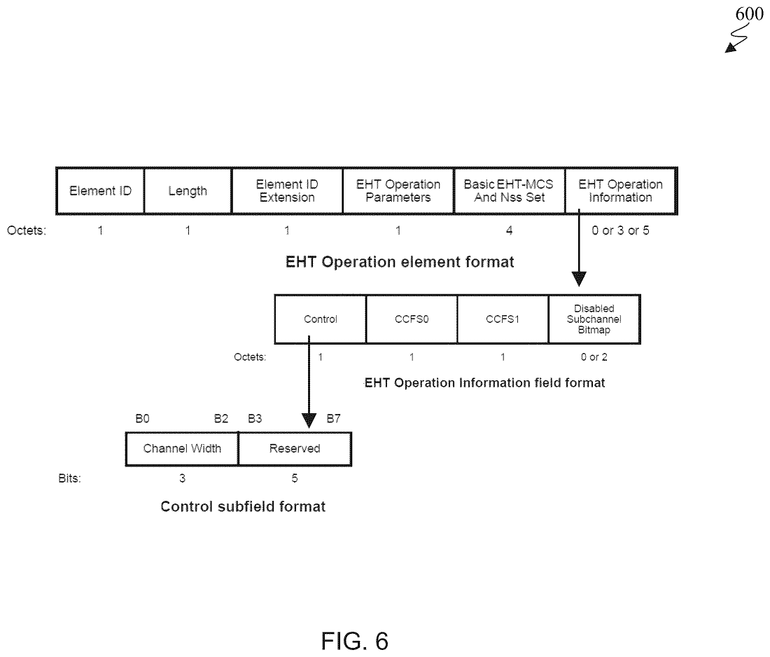

FIG. 6 illustrates an example of an extremely high throughput (EHT) operation element 600 that is transmitted by an EHT AP according to embodiments of the present disclosure. The embodiment of the extremely high throughput (EHT) operation element 600 shown in FIG. 6 is for illustration only. Other embodiments of the extremely high throughput (EHT) operation element 600 could be used without departing from the scope of this disclosure.

To indicate the current operating parameters of a basic service set (BSS), the AP transmits one or more Operations elements in its beacons, probe response and association response frames. The AP uses the primary channel field of the HT Operations element to indicate a current primary 20 MHz channel. It also uses the Secondary Channel Offset field to indicate the location of a secondary 20 MHz channel if CW>=40 MHz. The CCFS0/CCFS1 fields of the VHT Operation element (or HE element if VHT is not present) indicate the location of the primary and secondary 80 MHz channels. The CCFS0/CCFS1 fields EHT Operation element indicates the primary and secondary 160 MHz channels. The STA Channel Width field of the HT Operations +Channel width of the VHT Operation element+Channel width of the HE Operation element +Channel width of EHT Operation element jointly indicate the operating CW of the BSS. When operating in channels where HT/VHT etc. elements are not present, these fields are replicated in the HE Operation element. For example, the operation of EHT STAs in an EHT BSS is controlled by:
The HT Operation element, HE Operation element, and EHT Operation element if operating in the 2.4 GHz band
The HT Operation element, VHT Operation element (if present), HE Operation element, and EHT Operation element if operating in the 5 GHz band
The HE Operation element and EHT Operation element if operating in the 6 GHz band.

The Basic HT/VHT/HE/EHT MCS and NSS Set of the HT/VHT/HE/EHT Operations element is what all STAs in the BSS must support at the minimum for HT/VHT/HE/EHT PPDUs. As an example, the format of the EHT Operation element is depicted in FIG. 6.

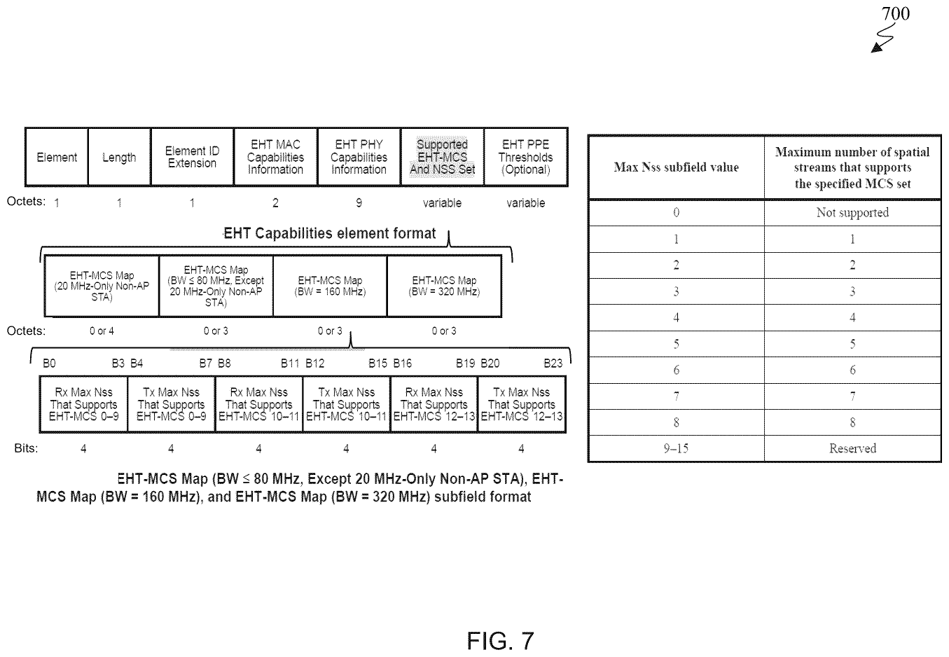

FIG. 7 illustrates an example of an EHT capabilities element 700 transmitted by an EHT STA according to embodiments of the present disclosure. The embodiment of the EHT capabilities element 700 shown in FIG. 7 is for illustration only. Other embodiments of the EHT capabilities element 700 could be used without departing from the scope of this disclosure.

To indicate the different channel widths, modulation and coding schemes (MCS) and number of spatial streams (NSS) that a STA supports, each STA also transmits a Capabilities element. An illustration of the EHT Capabilities element is depicted in FIG. 7. In the Supported Channel Width Set field of the Capabilities element, a STA indicates the different channel widths it supports. For an AP, this is a super set of the current BSS channel width indicated in Operations element(s). The MCS and NSS that can be supported at each CW is indicated in the Supported MCS and NSS Set field of the Capabilities element. The encoding is quite different for VHT, HE and EHT.
For HT there is a 77-bit bitmap whose bit i is set to 1 if MCS i is supported. The values are common to all channel widths.
For VHT, the MCS that can be supported for each NSS is indicated in the range {0-7,0-8,0-9} in a 16-bit Supported MCS and NSS Set field. The values are common to all channel widths. Difference in the NSS Supported for each CW is identified from the ‘Supported Channel Width Set’+‘Extended NSS CW Support’ fields.
For HE, the MCS that can be supported for each NSS is indicated in the “Tx/Rx HE-MCS Map” subfields of the “Supported HE MCS and NSS Set” field of the HE capabilities element (similar to VHT). However, the Map is separate for each bandwidth range.
For EHT, the maximum NSS (for TX and RX respectively) for each MCS is indicated in the “EHT-MCS Map” subfield of the “Supported EHT MCS and NSS Set” field of the EHT capabilities element. Indication is separate for each MCS range {0-9,10-11,12-13} and is different for each Bandwidth.

The capabilities element is a “per link indication” and is transmitted by a non-AP STA in:
Mandatorily carried in an Association/reassociation request frame sent by a non-AP STA.
Mandatorily present in a probe request frame sent by a non-AP STA.
Mandatorily present in a TDLS Discovery Request/Response frame.

The capabilities element is a “per link indication” and is transmitted by an AP STA in:
Mandatorily carried in a beacon frame transmitted by the AP.
Mandatorily carried in an Association/reassociation response frame transmitted by the AP.
Mandatorily carried in a probe response frame transmitted by the AP.

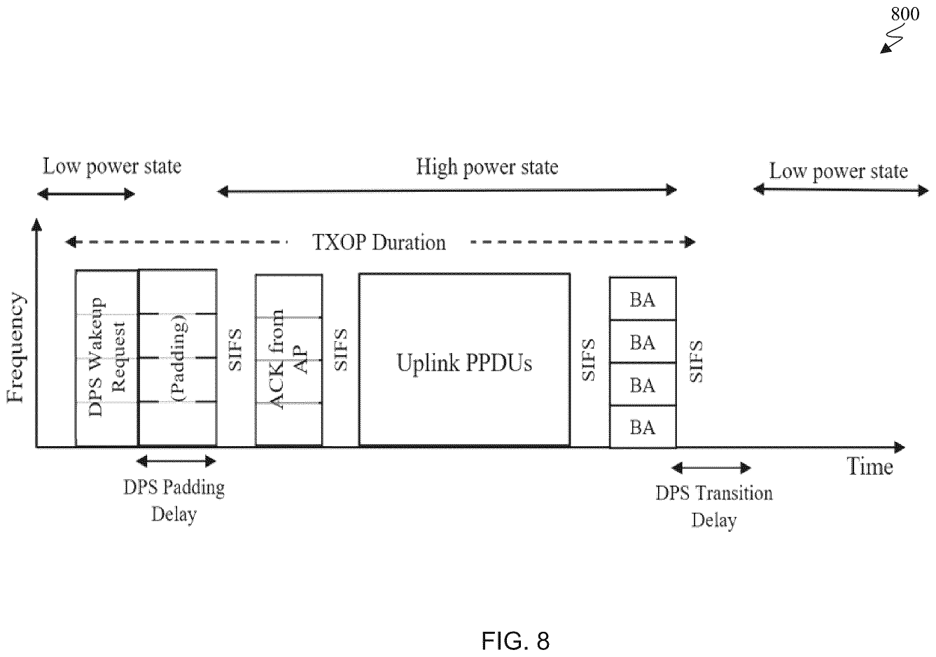

FIG. 8 illustrates an example of DPS operation of an AP during an uplink transmission 800 according to embodiments of the present disclosure. The DPS operation of an AP during an uplink transmission 800 can be performed by any of the APs 101, 103 of FIG. 1. The embodiment of the DPS operation of an AP during an uplink transmission 800 shown in FIG. 8 is for illustration only. Other embodiments of the DPS operation of an AP during an uplink transmission 800 could be used without departing from the scope of this disclosure.

More recently in the discussions for IEEE 802.11bn, significant attention has been paid towards the need to reduce the power consumption at the AP side. However, most existing power saving mechanisms for an AP, such as use of operating mode procedures, work at a slow time scale and can cause a significant reduction in the network throughput. To save AP power consumption and minimize the degradation in performance for latency sensitive traffic, Dynamic Power Save (DPS) operation has been proposed. In DPS mode, by default the AP may operate in a low power state with reduced capabilities, e.g., one or more of reduced supported channel width, reduced supported limited Physical Protocol Data Unit (PPDU) formats, reduced supported MCS set and NSS set, etc. Operating with these reduced capabilities may help the AP save power. However, upon receiving a request within a TXOP, the AP can transition to a high power state, wherein it increases one or more of its supported channel width (CW), supported PPDU formats, supported MCS set and NSS set for at least the duration of the TXOP. Thus, after sending a request to the AP to increase the capabilities of an AP, the TXOP owner can perform communication at the enhanced high-power state parameters for the rest of the TXOP, with better spectral efficiency. After the end of the TXOP or after a predetermined amount of time from the end of the TXOP, the AP may return to its low power state. An example illustration of this operation is depicted pictorially in FIG. 8.

Two types of Dynamic Power Save modes may be defined:
Option 1: Dynamic power saving (DPS) with restriction on CW, NSS, MCS: The AP has two states of operation: a low power (low capability) state and a high power (full capability) state. It operates in a low power state by default, where there are restrictions on (i) the supported channel width (CW), (ii) the supported NSS and (iii) supported MCS. It transitions to a high-power state on demand, after receiving an initial control frame (ICF) from a peer STA. For example, the low power state may support 20 MHz CW, 1 SS and MCS at or below a threshold such as MCS 3. These values may be predefined by the standard or may be configurable.
Option 2: Dynamic power saving (DPS) with restriction on CW, NSS, MCS and PPDU format: This is similar to option 1, but the low power state additionally has a restriction on the decodable PPDU formats compared to high power state. For example, the low power state can be similar to the EMLSR listen state, which supports 20 MHz CW, 1 SS and only non-HT frames at rates 24 Mbps or below. In some variants of option 2, the AP may not have transmit capabilities when operating in the low power state.

Embodiments of the present disclosure recognize that several types of STAs may be incompatible with DPS operation at the AP, referred to herein as incompatible STAs, for convenience. For example, some STA, such as a pre-UHR STA, only maintains a single capability state of the AP, and presumes the AP to always be available. It is not aware of the AP capability to transition between low power and high-power states. Correspondingly, when an AP enables DPS mode, a mechanism to handle already associated incompatible STAs is desirable. Additionally, mechanisms for unassociated incompatible STAs to perform association with an AP in DPS mode are desirable. Finally, mechanisms for an AP to serve incompatible STAs while operating in DPS mode are desirable.

Accordingly, embodiments of the present disclosure provide mechanisms for interaction of an AP operating in DPS mode with incompatible STAs that do not support DPS operation of the AP, during enablement of DPS mode, during DPS operation, and after disablement of DPS mode.

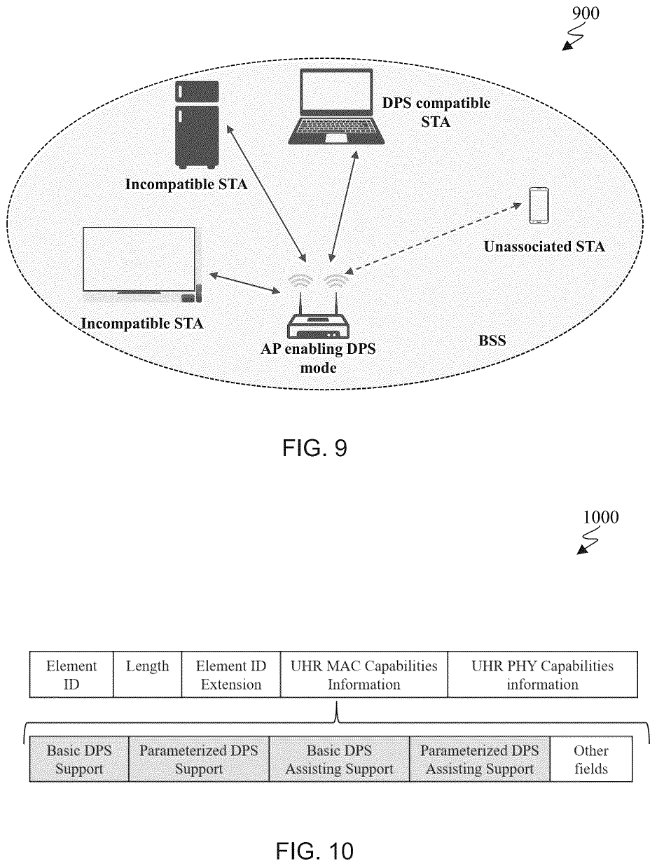

FIG. 9 illustrates an example of a scenario of an AP enabling DPS mode with several associated STAs 900 according to embodiments of the present disclosure. The scenario of an AP enabling DPS mode with several associated STAs 900 of FIG. 9 can be performed by any of the STAs 111-114 of FIG. 1, such as the STA 111 of FIG. 3, and any of the APs 101, 103 of FIG. 1, such as the AP 101 of FIG. 2. The embodiment of the scenario of an AP enabling DPS mode with several associated STAs 900 shown in FIG. 9 is for illustration only. Other embodiments of the scenario of an AP enabling DPS mode with several associated STAs 900 could be used without departing from the scope of this disclosure.

FIG. 10 illustrates an example of a UHR capabilities element 1000 indicating a STA's ability to support DPS operation or assist DPS operation at a peer STA according to embodiments of the present disclosure. The embodiment of the UHR capabilities element 1000 shown in FIG. 10 is for illustration only. Other embodiments of the UHR capabilities element 1000 could be used without departing from the scope of this disclosure.

As illustrated in FIG. 9, an AP operating a Basic Service Set (BSS) with several associated STAs is shown, where some of the STAs may be DPS compatible UHR STAs, and some of the STAs may be DPS incompatible STAs. There may also be several unassociated STAs which may intend to associate with the AP later. For implementation specific reasons, the AP may choose to enable or disable DPS mode. Note that, without loss of generality, the AP can be a mobile AP. In the present disclosure, the terms bandwidth and channel width (CW) are used interchangeably. In the present disclosure, a “limited MCS set” may imply a limitation on the modulations, on the code rates, or both of transmissions. Further, although the term AP is used, embodiments of the present disclosure may also be applicable for a mobile AP, a soft AP in a peer-to-peer network, or a non-AP MLD.

Incompatible DPS STAs may include one or more of: (i) STAs that do not support DPS operation at a peer STA, (ii) STAs that can operate with a DPS peer STA but without supporting DPS operation, (iii) STAs that cannot operate with a DPS peer STA, etc.

### Incompatible STAs

In some embodiments, all STAs before a certain Wi-Fi generation may be incompatible with DPS operation at the AP. In some embodiments, a UHR STA may have a capability indication in its UHR Capabilities element to indicate if it is compatible with DPS operation at the peer STA or not. The UHR STA may be either an AP or a non-AP STA and the peer STA may correspondingly be a non-AP STA or the AP STA, respectively. This field can be called, for example, the DPS Assisting Support field. In one variant of this embodiment, the capability indication by the UHR STA may be separate for whether it supports DPS Option 1 and DPS Option 2 at the peer STA, as described above. These two options may be referred to as the Parameterized DPS mode and Basic DPS mode, respectively. The capability indication can then be carried in fields called the Parameterized DPS Basic Assisting Support and Basic DPS Assisting Support, respectively of the UHR Capabilities element, as shown in FIG. 10. Similarly, in one embodiment, there may also be separate fields called Basic DPS Support and Parameterized DPS Support to indicate if the transmitting STA can itself enable Basic DPS operation or Parameterized DPS operation or not. In some embodiments, some previous generation STAs may become capable of supporting DPS operation via firmware or software updates. This capability to support DPS may be indicated by the STA to the AP using a frame or element. In one example, the indication can be in a vendor-specific element or frame. In another example, the indication can be in a new element or frame or field defined in 802.11bn. In another embodiment, the AP may determine the compatibility for DPS based on one or more of:
Wi-Fi generation of the non-AP STA
The make of the non-AP STA
Indication of capability support via spec defined or vendor-specific signaling.
The DPS Padding Delay applicable to the DPS AP to transition from low power state to high power state.
The DPS Transition Delay applicable to the DPS AP to transition from high power state to low power state.
The type of DPS mode being enabled by the AP (option 1 or option 2), i.e., the capabilities of the AP in the low power state.
Whether the AP has transmit capability when operating in the low power state.

For example, if the DPS Padding Delay is 0 for an AP, it may consider non-AP STAs from a larger set of Wi-Fi generations as DPS compatible, e.g., HE STAs and beyond. If the DPS Padding Delay is >0 for an AP, it may consider non-AP STAs from a smaller set of Wi-Fi generations as DPS compatible, e.g., only UHR STAs.

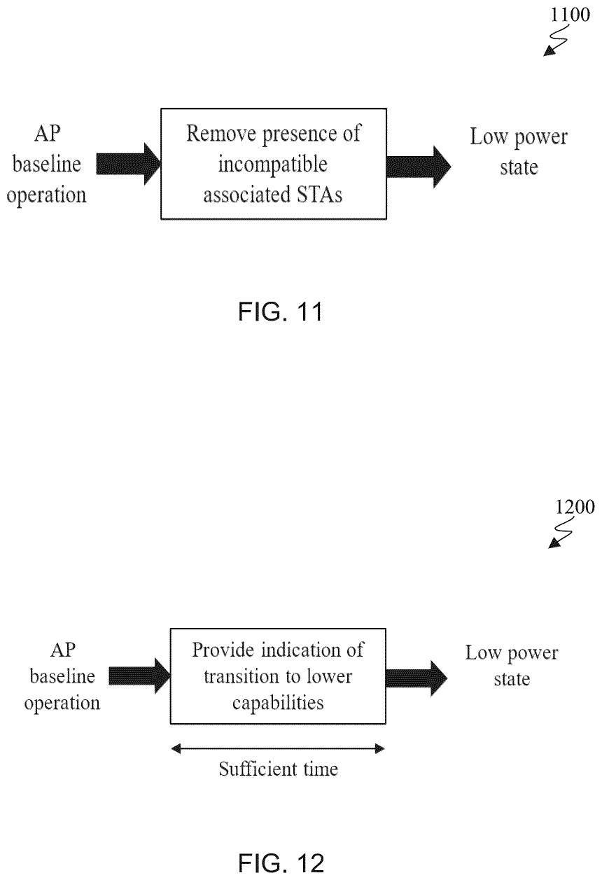

FIG. 11 illustrates an example of an AP removing incompatible STAs before enabling DPS mode and transitioning to the low power state 1100 according to embodiments of the present disclosure. The embodiment of the AP removing incompatible STAs before transitioning to the low power state 1100 shown in FIG. 11 is for illustration only. Other embodiments of the AP removing incompatible STAs before transitioning to the low power state 1100 could be used without departing from the scope of this disclosure.

### Interaction During DPS Enablement:

As illustrated in FIG. 11, when enabling DPS mode, the AP may transition from the full capability state (AP baseline operation) to the low power state, which may have restriction on the supported bandwidth, NSS, MCS and/or PPDU formats etc. Correspondingly, the AP may need to provide an indication of the reduced capabilities to associated incompatible STAs, if present, before enabling DPS mode. In one embodiment, the AP may not enable DPS mode if there are incompatible associated STAs present. In another embodiment, the AP may prevent the presence of incompatible associated STAs before enabling DPS mode by one or more of:
using BSS Transition Management procedures to transition associated incompatible STAs to other APs or links, before enabling DPS mode.
disassociating incompatible STAs before enabling DPS mode.

This procedure is depicted pictorially in FIG. 11. In a variant of this embodiment, the incompatible non-AP STAs may associate with the AP after the DPS is enabled. In another variant of this embodiment, the incompatible non-AP STAs may not be allowed to associate with the AP after DPS is enabled.

FIG. 12 illustrates an example of an AP providing an indication of reduced capabilities for sufficient time before enabling DPS mode and transitioning to the low power state 1200 according to embodiments of the present disclosure. The embodiment of the AP providing an indication of reduced capabilities for sufficient time before transitioning to the low power state 1200 shown in FIG. 12 is for illustration only. Other embodiments of the AP providing an indication of reduced capabilities for sufficient time before transitioning to the low power state 1200 could be used without departing from the scope of this disclosure.

As illustrated in FIG. 12, in some embodiments, the AP may allow incompatible associated STAs to maintain association with the AP while the AP transitions to the low power state. In order to do so, the AP may provide an indication of its reduced capabilities to the incompatible STAs for sufficient time before transitioning to the low power state. The indication can be carried, for example, in broadcast or management frames, such as beacon frames, probe response, association response frames etc. The sufficient time may be determined such that all associated incompatible STAs would have a chance to receive the indication with high likelihood. This procedure is depicted pictorially in FIG. 12. In a variant of this embodiment, the AP may ask the incompatible STAs to re-associate with the AP, so that the AP can indicate the updated reduced capabilities to these STAs. In one embodiment, a new mechanism for an AP to indicate to one or more associated non-AP STAs that satisfy certain criteria to re-associate with the AP may be defined. This can be done by defining a new broadcast frame, that also indicates the criteria to be satisfied by the non-AP STAs. Incompatible non-AP STAs may associate with the AP after the DPS is enabled using the baseline procedure. In another embodiment, an AP that is capable of DPS operation and that intends to transition to DPS mode at some time may indicate its reduced capabilities to DPS incompatible STAs since their association, even if DPS is disabled during the association. Correspondingly, the AP may always communicate with DPS incompatible STAs as per the low power state capabilities, even when DPS is disabled.

In some embodiments, there may be multiple classes of incompatible STAs, (i) ones for whom indication of AP capabilities in low power state can be provided using other mechanisms and correspondingly ones that can still operate with a DPS AP, (ii) for whom there are no mechanisms to indicate the AP's reduced capabilities in the low power state and so which cannot operate with a DPS AP. The other mechanisms for type (i) may include procedures defined in older Wi-Fi generation standards. Correspondingly, for STAs of type (ii) the mechanisms mentioned in FIG. 11 may be followed while for STAs of type (i) mechanisms in FIG. 12 may be used by the AP.

In some embodiments, the indication method of the reduced capabilities to follow may be dependent on the parameters of the DPS mode and the type of incompatible STAs associated. These may include:
The AP capabilities (CW, NSS, MCS, PPDU format support, etc.) before enabling the DPS mode
The AP capabilities (CW, NSS, MCS, PPDU format support, etc.) during the low power state
The AP capabilities (CW, NSS, MCS, PPDU format support, etc.) during the high power state
The type of DPS operation enabled by the AP, i.e., option 1 or option 2.
The Wi-Fi generation of the incompatible STA (non-HT/HT/VHT/HE/EHT/UHR etc.).
The DPS parameters of the AP, including the DPS Padding delay and DPS Transition delay.

In some embodiments, where the DPS Padding Delay and/or DPS Transition Delay are 0 for the AP, the AP may not directly signal the reduced operating parameters to the associated STAs. Instead, the AP may set the TXOP Duration RTS Threshold field of the HE Operation Parameters field of the HE Operations element to ensure that all transmissions with the AP by HE+STAs are initiated with an RTS-CTS exchange. This way, even though other non-AP STA may not be aware of the exact low power state capabilities of the AP, the transmission of the RTS by the AP gives it sufficient time to switch to the high power state. Here the other non-AP STA may be a device compliant with an older generation Wi-Fi standard. In one example the AP can set the TXOP Duration RTS Threshold field to a value of 1.

In some embodiments, the AP may not explicitly signal each of the CW, NSS, MCS, PPDU format supported in the low power state. Rather, the AP may skip the Operation elements corresponding to several Wi-Fi generations to make the DPS incompatible STAs think that the AP is of an older generation, for example, of the non-HT generation. Correspondingly, the DPS incompatible STAs may think the AP is only capable of the CW, NSS, MCS and PPDU format supported in those older Wi-Fi generation devices. In a variant of this case, the AP may ask the incompatible STAs to re-associate with the AP. For DPS compatible non-AP STAs and/or UHR non-AP STAs, the AP may separately signal its full capabilities including that it is a UHR AP.

### Supported CW Reduction Indication:

In some embodiments, the AP may indicate a reduction in its operating CW before enabling the DPS mode. The indicated operating CW can be, for example, the same or smaller than the supported CW in the low power state. To indicate a reduction in operating CW:
In one example, an AP may indicate a reduction in its operating channel width by including the Channel Switch Announcement element, Extended Channel Switch Announcement element or Operating Mode element in beacon frames, probe response and association response frames that it transmits.
In another example, an AP may also use a broadcast Channel Switch Announcement frame, Extended Channel Switch Announcement frame or Operating Mode Notification frame for such indication.
In another example, an AP may also provide the indication in the OM Control subfield of a QoS Data, QoS Null or Class 3 management frame that it transmits.

For example, if the AP supports 20 MHz as the channel width in the low power state, it may set the Channel Width field of the Operating Mode element or Operating Mode Notification frame or OM Control field to 0. In one embodiment, there may be a new field in the Operating Mode element or Operating Mode Notification frame or OM Control field to indicate that the reduction in bandwidth corresponds to the low power state of the DPS and/or is applicable to non-DPS supporting non-AP STAs. DPS compatible non-AP STAs which receive this indication may be able to identify whether the change in channel width indicated by the operating mode change impacts the high power state or low power state or both of the AP.

The reduced value of the supported Channel Width may also be indicated by the AP in the Operation elements and Capabilities elements it transmits in Beacon, Probe response and Association response frames. The changes may be included in all or a subset of the Capabilities and Operation elements {HT, VHT, HE, EHT, UHR}. For example, these indications can be carried in one or more of:
STA Channel Width field and Secondary Channel Offset field of the HT Operations element
Supported Channel Width Set field of the HT Capabilities element
Channel Width field and CCFS0/CCFS1 fields of the VHT Operations element
Supported Channel Width Set field and Extended NSS BW Support field of the VHT Capabilities element
Channel Width field and CCFS0/CCFS1 fields of the HE Operations element
Supported Channel Width Set field of the HE Capabilities element
Channel Width field and CCFS0/CCFS1 fields of the EHT Operations element
Supported Channel Width Set field of the EHT Capabilities element.

The change in these parameters may be indicated as a Critical Update. For example, if the AP supports 20 MHz as the channel width in the low power state, it may indicate the Operating bandwidth as 20 MHz in HT, VHT, HE and EHT Operation elements and CCFS1 field to 0 in VHT, HE and EHT Operation elements. Appropriate changes may also be indicated in the Capabilities element. In a variant, it may be understood that UHR non-AP STAs that do not support DPS also use the EHT Operating bandwidth as the operating bandwidth to be used by them.

After providing the indication for sufficient time to ensure all associated STAs may have received it, the AP may transition to the low power state. Incompatible STAs may be expected to operate with the AP using this indicated operating CW.

In some embodiments, incompatible UHR STAs may be expected to operate with the AP as per the operation bandwidth indicated by the AP in the latest generation pre-UHR Operations element (EHT>HE>VHT>HT). In another embodiment, the AP may carry an indication of the bandwidth applicable to the incompatible UHR STAs in frames it transmits, such as Beacon frames, Probe Response frames or Association Response frames. The indication may be carried in, for example, the UHR Operations element in a Channel Width field or a Nominal Channel Width field. In yet another embodiment, the spec may predefine the channel width that is supported in the low power state when DPS is enabled, and hence incompatible UHR STAs may know of the supported channel width based on whether the DPS is indicated as being enabled or not by the AP.

Supported NSS reduction indication:

In some embodiments, the AP may indicate a reduction in maximum supported receive NSS and/or transmitted NSTS before enabling the DPS mode. The indicated NSS can be, for example, the same or smaller than the supported maximum NSS in the low power state. To indicate reduction in NSS:
In one example, an AP may indicate a reduction in its RX NSS by including an Operating Mode element in beacon frames, probe response and association response frames that it transmits.
In another example, an AP may also use a broadcast Operating Mode Notification frame for such indication.
In another example, an AP may also provide the indication in the OM Control subfield of a QoS Data, QoS Null or Class 3 management frame that it transmits.

For example, if the AP supports 1 SS in the low power state, it may set the Rx NSS field of the Operating Mode element or Operating Mode Notification frame or OM Control field to 0. The Tx NSTS field may also be set to 0 in one example. In one embodiment, there may be a new field in the Operating Mode element or Operating Mode Notification frame or OM Control field to indicate that the reduction in the NSS corresponds to the low power state of the DPS and/or is applicable to non-DPS supporting non-AP STAs. DPS compatible non-AP STAs which receive this indication may be able to identify whether the change in NSS indicated by the operating mode change impacts the high power state or low power state or both of the AP.

The reduced maximum NSS supported may also be indicated by the AP in the Operation elements and Capabilities elements it transmits in Beacon, Probe response and Association response frames. The changes may be included in all or a subset of the Capabilities and Operation elements {HT, VHT, HE, EHT, UHR}. For example, these indications can be carried in one or more of:
Basic HT-MCS Set field of the HT Operations element
Supported MCS Set field and Transmit Beamforming Capabilities field of the HT Capabilities element
Basic VHT-MCS and NSS Set field of the VHT Operations element
Supported VHT-MCS and NSS Set field and Extended NSS BW Support field of the VHT Capabilities element
Basic HE-MCS and NSS Set field of the HE Operations element
Supported HE-MCS and NSS Set field of the HE Capabilities element
Basic EHT-MCS and NSS Set field of the EHT Operations element
Supported EHT-MCS and NSS Set field of the EHT Capabilities element.

The change in these parameters may be indicated as a Critical Update. For example, if the AP supports 1 spatial stream in the low power state, it may set:
The bits 8-76 of the Rx MCS Bitmask of the Basic MCS and NSS Set field are set to 0, in the HT Operations element to 0.
The bits 8-76 of the Rx MCS Bitmask field are set to 0 and the Tx Maximum Number Spatial Streams Supported field is set to 0, in the Supported MCS Set field of the HT Capabilities element.
The Extended NSS BW Support field to 0, and Max VHT-MCS For x SS field to 3 for x>1 in the Supported VHT-MCS and NSS Set field of the VHT Capabilities element.
The Max VHT-MCS For x SS field to 3 for x>1 in the Basic VHT-MCS and NSS Set of the VHT Operations element.
The Max HE-MCS For x SS field to 3 for x>1 in the Rx HE-MCS Map subfield and Tx HE-MCS Map subfield of the Basic HE-MCS And NSS Set field of the HE Operations element.
The Max HE-MCS For x SS field to 3 for x>1 in the Rx HE-MCS Map fields and Tx HE-MCS Map fields of the Supported HE-MCS And NSS Set field of the HE Capabilities element.
The Rx Max NSS That Supports EHT-MCS fields and Tx Max NSS That Supports EHT-MCS fields are all set to either 0 or 1 (depending on the MCS supported) in the EHT-MCS Map field of the Basic EHT-MCS And NSS Set field of the EHT Operations element.
The Rx Max NSS That Supports EHT-MCS fields and Tx Max NSS That Supports EHT-MCS fields are all set to either 0 or 1 (depending on the MCS supported) in the EHT-MCS Map field of the Supported EHT-MCS And NSS Set field of the EHT Capabilities element.

After providing the indication for sufficient time to ensure all associated STAs may have received it, the AP may transition to the low power state. Incompatible STAs may be expected to operate with the AP up to the indicated RX NSS values.

In some embodiments, incompatible UHR STAs may be expected to operate with the AP as per the supported MCS and NSS sets indicated by the AP in the latest generation pre-UHR Operations element (EHT>HE>VHT>HT). In another embodiment, the AP may carry an indication of the MCS and NSS combinations applicable to the incompatible UHR STAs in frames it transmits, such as Beacon frames, Probe Response frames or Association Response frames. The indication may be carried in, for example, the UHR Capabilities element in the Reduced UHR MCS and NSS Set fields. In yet another embodiment, the spec may predefine the NSS that is supported in the low power state when DPS is enabled, and hence incompatible UHR STAs may know of the supported NSS based on whether the DPS is indicated as being enabled or not by the AP.

### Supported MCS Reduction Indication

In one embodiment, the AP may indicate a reduction in supported MCS set or maximum supported data rate before enabling the DPS mode. In a variant the reduction in MCS may refer to a reduction in the supported modulations and/or code rates. The indicated MCS sets and data rates can be, for example, the same or a subset of the supported MCS sets and data rates in the low power state. To indicate reduction in MCS sets, in one example, the AP may update one or more of: (i) the Basic MCS and NSS Set field of the Operation elements and (ii) the MCS and NSS Sets tables broadcast by the AP in the Capabilities elements of Beacon, Probe response and Association response frames. The changes may be included in all or a subset of the Capabilities and Operation elements {HT, VHT, HE, EHT, UHR}. In addition, for a non-HT case, the indication of reduction in supported rates may be carried in the Supported Rates and BSS Membership Selectors element of the Beacon frames. For example, these indications can be carried in one or more of:
Supported Rates and BSS Membership Selectors element
Basic HT-MCS Set field of the HT Operations element
Supported MCS Set field and Transmit Beamforming Capabilities field of the HT Capabilities element
Basic VHT-MCS and NSS Set field of the VHT Operations element
Supported VHT-MCS and NSS Set field and Extended NSS BW Support field of the VHT Capabilities element
Basic HE-MCS and NSS Set field of the HE Operations element
Supported HE-MCS and NSS Set field of the HE Capabilities element
Basic EHT-MCS and NSS Set field of the EHT Operations element
Supported EHT-MCS and NSS Set field of the EHT Capabilities element.

The change in these parameters may be indicated as a Critical Update. In one variant, if the indication in the aforementioned elements does not provide sufficient granularity to indicate the maximum supported MCS, an MCS smaller or larger than the maximum supported MCS in the low power state may be indicated by the AP, and additional mechanisms such as link adaptation may be used to handle the limited MCS issue, as described later. For example, if the AP supports modulation up to 64-QAM and Code rate≤5/6 (for HT or beyond PPDUs) and Rate≤24 Mbps (for non-HT PPDUs) in the low power state, it may set:
AP updates Supported Rates and BSS Membership Selectors element in Beacon frames to indicate support for ≤24 Mbps.
The bits B32-76 of the Rx MCS Bitmask of the Basic MCS and NSS Set field are set to 0, in the HT Operations element to 0.
The bits B7, B15, B23, B31 and bits B32-76 of the Rx MCS Bitmask field are set to 0, in the Supported MCS Set field of the HT Capabilities element.
The Max VHT-MCS For x SS field of the Rx VHT-MCS Map and Tx VHT-MCS Map is set to 0 for each supported spatial streams x in the Supported VHT-MCS and NSS Set field of the VHT Capabilities element.
The Max VHT-MCS For x SS field of the Rx VHT-MCS Map and Tx VHT-MCS Map is set to 0 for each supported spatial streams x in the Basic VHT-MCS and NSS Set of the VHT Operations element.
The Max HE-MCS For x SS field of the Rx HE-MCS Map and Tx HE-MCS Map is set to 0 for each supported spatial streams x in the Rx HE-MCS Map subfield and Tx HE-MCS Map subfield of the Basic HE-MCS And NSS Set field of the HE Operations element.
The Max HE-MCS For x SS field of the Rx HE-MCS Map and Tx HE-MCS Map is set to 0 for each supported spatial streams x of the Supported HE-MCS And NSS Set field of the HE Capabilities element.
The Rx Max NSS That Supports EHT-MCS fields and Tx Max NSS That Supports EHT-MCS x fields are set to 0 for x>7 in the EHT-MCS Map field of the Basic EHT-MCS And NSS Set field of the EHT Operations element. In one example, the value of x can be 9.

After providing the indication for sufficient time to ensure all associated STAs may have received it, the AP may transition to the low power state.

In some embodiments, the AP may also rely on the link adaptation mechanism of Wi-Fi to enable incompatible non-AP STAs to perform frame exchanges with the AP as per the AP's low power state capabilities. For example, if an incompatible non-AP STA initiates transmission at an MCS that isn't supported by the AP in the low power state, the frame exchange may fail and correspondingly over time the non-AP STA may adapt to the MCS which is supported by the AP in the low power state. In one variant of this embodiment, if an AP receives a frame from an incompatible non-AP STA while the AP is in high power state and/or the AP receives a frame successfully at an MCS that isn't supported by the AP in the low power state, it may not respond to the non-AP STA to ensure that the link adaptation mechanism at the non-AP STA works correctly and picks MCS less than the max MCS supported by the AP in the low power state. This mechanism may be used, for example, if the AP indicates a support for EHT MCS 0-9 to EHT STAs in the EHT Capabilities and Operations elements, but the supported maximum MCS in the low capability state is smaller, for example, MCS 6.

In some embodiments, incompatible UHR STAs may be expected to operate with the AP as per the supported MCS and NSS sets indicated by the AP in the latest generation pre-UHR Operations element (EHT>HE>VHT>HT). In another embodiment, the AP may carry an indication of the MCS and NSS combinations applicable to the incompatible UHR STAs in frames it transmits, such as Beacon frames, Probe Response frames or Association Response frames. The indication may be carried in, for example, the UHR Capabilities element in the Reduced UHR MCS and NSS Set fields. In yet another embodiment, the spec may predefine the MCS that is supported in the low power state when DPS is enabled, and hence incompatible UHR STAs may know of the supported MCS based on whether the DPS is indicated as being enabled or not by the AP.

### Supported PPDU Format Reduction Indication:

In some embodiments, the AP may indicate a reduction in supported PPDU formats before switching to the DPS mode. To indicate reduction in supported PPDU formats, the AP may skip the Operation elements and Capabilities elements that it transmits in Beacon, Probe response and Association response frames. The changes may be included in all or a subset of the Capabilities and Operation elements {HT, VHT, HE, EHT, UHR}. The skipping of these elements may be indicated as a Critical Update. In addition, the AP may skip any other generation-specific fields corresponding to a subset of the generations {HT, VHT, HE, EHT, UHR}, from broadcast or management frames such as Beacon, Probe response and Association response frames. The exclusion of such fields may be such that incompatible STAs think the AP is of an older generation. In one embodiment, the AP may disassociate incompatible STAs before performing this operation, and allow them to re-associate. After providing the indication for sufficient time to ensure all associated STAs may have received it, the AP may transition to the low power state. In another embodiment, all PPDU formats may be supported by the DPS AP in the low power state, in which case, no new indication may be required for incompatible STAs.

In some embodiments, incompatible UHR STAs may be expected to operate with the AP as per the latest pre-UHR PPDU format supported by the AP, as indicated by the latest generation pre-UHR Operations element (EHT>HE>VHT>HT) it carries in Beacon, Probe Response and/or Association Response frames. In another embodiment, the AP may carry an indication of the PPDU formats applicable to the incompatible UHR STAs in frames it transmits, such as Beacon frames, Probe Response frames or Association Response frames. The indication may be carried in, for example, the UHR Capabilities element in the Reduced Capability PHY Version field. In yet another embodiment, the spec may predefine the PPDU formats that are supported in the low power state when DPS is enabled, and hence incompatible UHR STAs may know of the supported PPDU formats based on whether the DPS is indicated as being enabled or not by the AP.

In some embodiments, the spec may predefine one or more options for the supported channel width, MCS, NSS and PHY version in the low capability state of DPS operation. Correspondingly, when enabling DPS, the identifier for the applicable option may be indicated in the frame transmitted by the AP to enable DPS mode. For example, some options are as follows: Option 0:{20 MHz, 1SS, non-HT PPDUs with rate <24 Mbps}, Option 1:{20 MHz, 1SS, up to UHR PPDUs, MCS 0-6}, Option 2:{20 MHz, 1SS, up to UHR PPDUs, MCS 0-9}, Option 3: {40 MHz, 1SS, up to UHR PPDUs, MCS 0-6}, etc.

### Transmission to Incompatible STAs After DPS Enablement:

In some embodiments, after the AP DPS mode is enabled, the incompatible STAs may communicate with the AP as per the reduced CW, NSS, MCS and PPDU formats indicated to the STAs before enabling DPS mode.

### Association of Stas After DPS Enablement:

In some embodiments, the AP may be capable of receiving a probe request from an unassociated STA, if the probe request frame complies with the low power state capabilities of the AP. In one embodiment, the AP may not be capable of transmission when operating in the low power state. Upon receiving a probe request from an unassociated STA, the AP may first transition to the high power state and it may then transmit a probe response frame. In another embodiment, the AP may be capable of transmission in the low power state. Correspondingly upon receiving a probe request frame an unassociated STA, the AP may immediately transmit a probe response frame if required. In one embodiment, the AP may not permit incompatible STAs from associating with it. In one embodiment, the AP may disable DPS mode when an incompatible STA attempts association with it. In another embodiment, the AP may allow other STAs to associate with it. As discussed before, the probe response and association response frames transmitted by the AP after enabling DPS mode may carry indication of the reduced CW, NSS, MCS and PPDU format support.

### Supporting Advanced PHY Features:

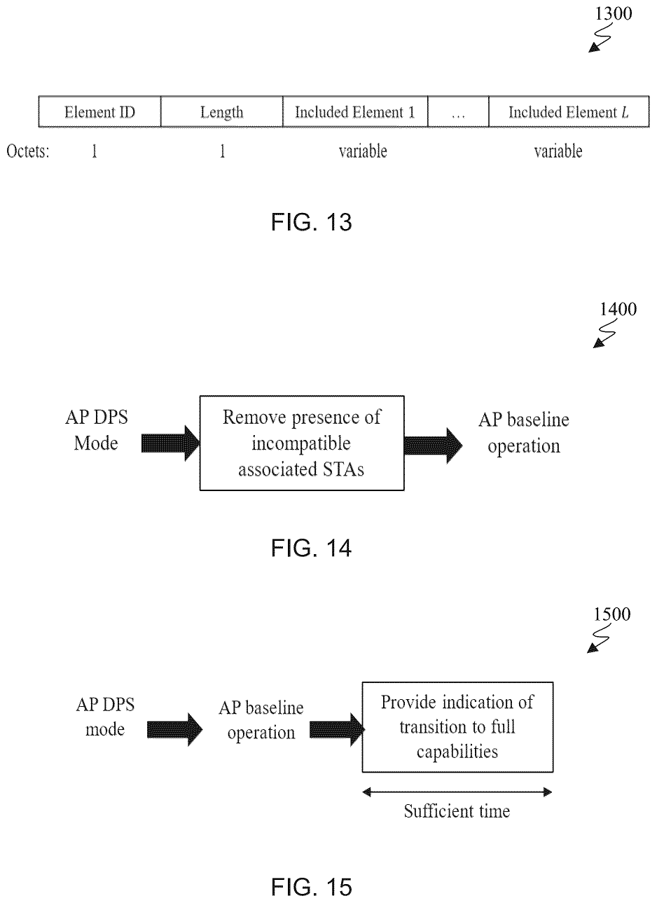

FIG. 13 illustrates an example of a DPS wrapper element 1300 which can hold one or more previous generation elements according to embodiments of the present disclosure. The embodiment of the example DPS wrapper element 1300 shown in FIG. 13 is for illustration only. Other embodiments of the example DPS wrapper element 1300 could be used without departing from the scope of this disclosure.

In some embodiments, where the AP has reduced PHY version support during the low power state, it may skip elements of specific generations from beacon frames. For example, if the AP supports only EMLSR listen operation in the low power state, it may skip the HT, VHT, HE and EHT Operation elements and/or Capabilities elements from its beacon, probe response and association response frames. Correspondingly, several features, such as MPDU aggregation, WPA2, WPA3, multi-link operation, target wake time, block acknowledgement, MIMO, OFDMA etc., may not be available for the incompatible STAs.

In some embodiments, one or more of the skipped fields from Operation elements and Capabilities elements may be included in some new UHR elements defined for supporting DPS operation. In one variant, a DPS Wrapper element may be defined in UHR that can hold any of these previous generation elements which were skipped from the beacons, probe response, association response frames etc. Each such DPS Wrapper element can be designed to hold one or more of these elements.

Thus, the AP may include all such skipped elements from the beacon, probe response and association response frames within the DPS Wrapper element and reintroduce them within those frames. The DPS Wrapper elements may be ignored by incompatible STAs. An example illustration of this element is depicted in FIG. 13. The included elements can be identified from the Element ID of the included element.

In some embodiments, the AP may include one or more of these skipped fields in some UHR-specific fields of frames that it transmits or in some UHR-specific frames that it transmits. For example, there may be a UHR-specific subfield of the Beacon frame to carry these indications. In another example, there may be a separate UHR-specific follow-up group-addressed frame to the Beacon frame which can carry such skipped fields.

### Interaction After DPS Disablement:

FIG. 14 illustrates an example of an AP removing incompatible STAs before disabling the DPS mode 1400 according to embodiments of the present disclosure. The embodiment of the AP removing incompatible STAs before disabling the DPS mode 1400 shown in FIG. 14 is for illustration only. Other embodiments of the AP removing incompatible STAs before disabling the DPS mode 1400 could be used without departing from the scope of this disclosure.

After disabling the DPS mode, the AP may transition back to the full capability state (AP baseline operation). Correspondingly, the AP may need to provide an indication of the enhanced capabilities to associated incompatible STAs, if present, after disabling the DPS mode. In another embodiment, the AP may prevent the presence of incompatible associated STAs during disabling the DPS mode by one or more of:
using BSS Transition Management procedures to transition associated incompatible STAs to other APs or links, before disabling the DPS mode.
disassociating incompatible STAs before disabling the DPS mode.

This procedure is depicted pictorially in FIG. 14.

FIG. 15 illustrates an example of an AP providing an indication of return to full capabilities for sufficient time after disabling DPS mode and transitioning to the full capability state 1500 according to embodiments of the present disclosure. The embodiment of the AP providing an indication of return to full capabilities for sufficient time after transitioning to the full capability state 1500 shown in FIG. 15 is for illustration only. Other embodiments of the AP providing an indication of return to full capabilities for sufficient time after transitioning to the full capability state 1500 could be used without departing from the scope of this disclosure.

In some embodiments, the AP may allow incompatible associated STAs to maintain association with the AP while the AP disables the DPS mode. In order to do so, the AP may provide an indication of its enhanced capabilities to the incompatible STAs for sufficient time after transitioning to full capability state. The indication can be carried, for example, in broadcast or management frames, such as beacon frames, probe response, association response frames etc. The sufficient time may be determined such that all associated incompatible STAs would have a chance to receive the indication with high likelihood. This procedure is depicted pictorially in FIG. 15. The mechanisms for the indication can be similar to the ones used to indicate restrictions to CW, NSS, MCS described above. For indicating an increase in the PPDU format decoding capability, the AP can reintroduce the corresponding generation elements back into the management frames (beacons, probe response, association response) that it transmits and remove a DPS Wrapper element.

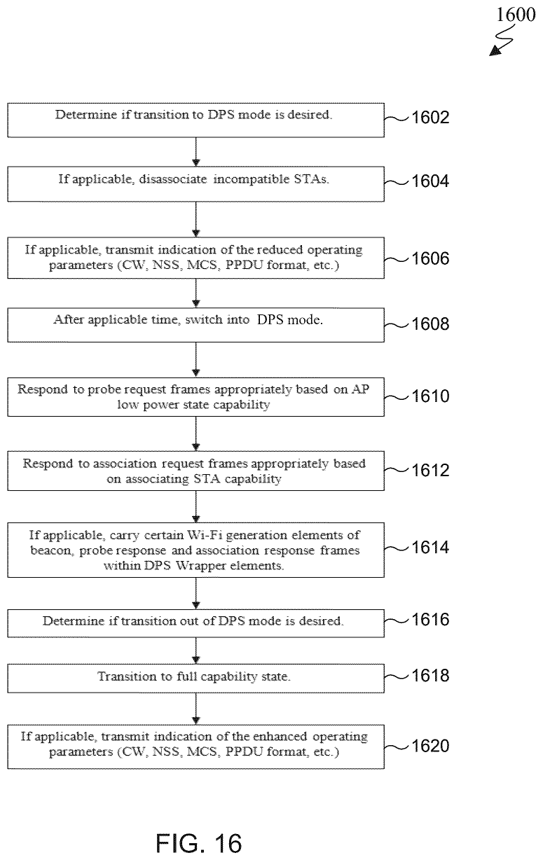

FIG. 16 illustrates an example method 1600 performed by an AP for supporting incompatible STAs during DPS operation according to embodiments of the present disclosure. The method 1600 of FIG. 16 can be performed by any of the APs 101, 103 of FIG. 1, such as AP 101 of FIG. 2. The method 1600 shown in FIG. 16 is for illustration only. Other embodiments of the method 1600 could be used without departing from the scope of this disclosure.

As illustrated in FIG. 16, the method 1600 begins at step 1602, where a determination is made whether a transition to the DPS mode is desired. When a transition to the DPS mode is desired, then at step 1604, incompatible STAs are disassociated, if applicable. At step 1606, an indication of the reduced operating parameters (CW, NSS, MCS, PPDU format, etc.) is transmitted, if applicable. At step 1608, after an applicable time, the AP switches into the DPS mode. At step 1610, the AP responds to probe request frames received from a STA that are appropriately based on the AP low power state capability. At step 1612, the AP responds to association request frames received from a STA that are appropriately based on associating STA capability. At step 1614, the AP carries certain Wi-Fi generation elements of beacon, probe response and association response frames within DPS Wrapper elements, if applicable. At step 1616, a determination is made whether transition out of the DPS mode is desired. At step 1618, when transition out of the DPS mode is desired, the AP transitions to the full capability state. At step 1620, the AP transmits an indication of the enhanced operating parameters (CW, NSS, MCS, PPDU format, etc.), if applicable.

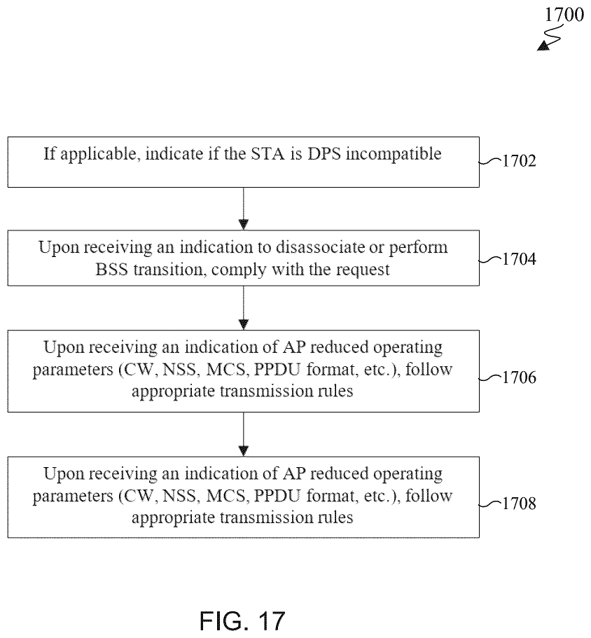

FIG. 17 illustrates an example method 1700 performed by a DPS incompatible STA during DPS operation according to embodiments of the present disclosure. The method 1700 of FIG. 17 can be performed by any of the APs 101, 103 of FIG. 1, such as AP 101 of FIG. 2. The method 1700 shown in FIG. 17 is for illustration only. Other embodiments of the method 1700 could be used without departing from the scope of this disclosure.

As illustrated in FIG. 17, the method 1700 begins at step 1702, where the STA indicates that it is DPS incompatible. At step 1704, upon receiving an indication to disassociate or perform BSS transition, the STA complies with the request. At step 1706, upon receiving an indication of AP reduced operating parameters (CW, NSS, MCS, PPDU format, etc.), the STA follows the appropriate transmission rules. At step 1708, upon receiving an indication of AP reduced operating parameters (CW, NSS, MCS, PPDU format, etc.), the STA follows the appropriate transmission rules.

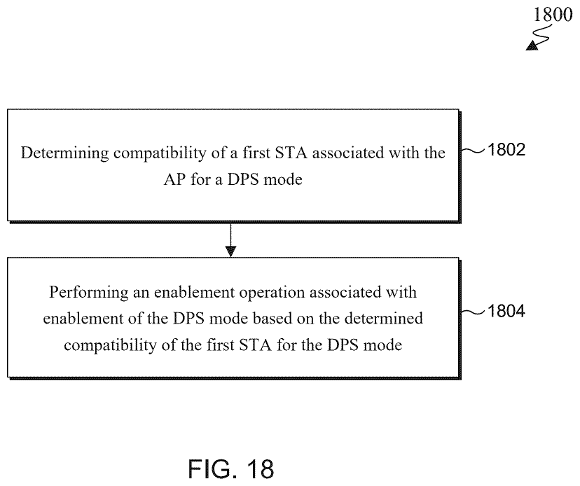

FIG. 18 illustrates another example method 1800 performed by an AP in a wireless communication system for supporting incompatible STAs during DPS operation according to embodiments of the present disclosure. The method 1800 of FIG. 18 can be performed by any of the APs 101, 103 of FIG. 1, such as AP 101 of FIG. 2. The method 1800 shown in FIG. 18 is for illustration only. Other embodiments of the method 1800 could be used without departing from the scope of this disclosure.

As illustrated in FIG. 18, the method 1800 begins at step 1802, where the AP determines compatibility of a first STA associated with the AP for a DPS mode. At step 1804, the AP performs an enablement operation associated with enablement of the DPS mode based on the determined compatibility of the first STA for the DPS mode.

In some embodiments, the AP is configured to not enable the DPS mode when the determined compatibility of the first STA is incompatible with the DPS mode.

In some embodiments, the AP is configured to: enable the DPS mode when the determined compatibility of the first STA is incompatible with the DPS mode; and during enablement of the DPS mode when the determined compatibility of the first STA is incompatible with the DPS mode, maintain association with the first STA while transitioning from a high power state to a low power state by providing an indication of reduced capabilities to the first STA before enabling the DPS mode, wherein the reduced capabilities and the method of indication are based on parameters of the DPS mode or a type of the first STA.

In some embodiments, the indication of reduced capabilities comprises an indication of a reduced channel width included in an operating mode notification frame or operating mode element, operation elements, or capabilities elements, corresponding to one or more Wi-Fi generations, transmitted in a frame by the AP.

In some embodiments, the indication of reduced capabilities comprises an indication of a reduced number of spatial streams (NSS) included in an operating mode notification frame or operating mode element, operation elements, or capabilities elements, corresponding to one or more Wi-Fi generations, transmitted in a frame by the AP.

In some embodiments, the indication of reduced capabilities comprises an indication of a reduced modulation and coding scheme (MCS) included in an operating mode element, an operating mode notification frame, operation elements, or capabilities elements.

In some embodiments, the reduced capabilities comprises one or more of a reduced channel width, a reduced number of spatial streams (NSS), a reduced modulation and coding scheme (MCS) or a reduced physical protocol data unit (PPDU) supported by the AP, which are indicated by exclusion of operation elements, or capabilities elements corresponding to one or more Wi-Fi generations in a frame transmitted by the AP.

In some embodiments, the AP is configured to communicate with the first STA based on the reduced capabilities that were indicated to the first STA before enabling the DPS mode.

In some embodiments, the AP is configured to: receive, from a second STA not associated with the AP, a probe request that complies with the reduced capabilities indicated to the first STA; and transmit a probe response to the second STA.

In some embodiments, the AP is configured to: disable the DPS mode; and during disablement of the DPS mode, maintain association with the first STA while transitioning from the low power state to the high power state by providing an indication of enhanced capabilities to the first STA after disabling the DPS mode, wherein the enhanced capabilities are based on the parameters of the DPS mode or the type of the first STA.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by an access point (AP), the method comprising:
determining a compatibility of a first station (STA) associated with the AP for a dynamic power save (DPS) mode; and
performing an enablement operation associated with enablement of the DPS mode based on the determined compatibility of the first STA for the DPS mode.

2. The method of claim 1, wherein performing the enablement operation further comprises not enabling the DPS mode when the determined compatibility of the first STA is incompatible with the DPS mode.

3. The method of claim 1, wherein performing the enablement operation further comprises:
enabling the DPS mode when the determined compatibility of the first STA is incompatible with the DPS mode; and
during enablement of the DPS mode when the determined compatibility of the first STA is incompatible with the DPS mode, maintaining association with the first STA while transitioning from a high power state to a low power state by providing an indication of reduced capabilities to the first STA before enabling the DPS mode, wherein the reduced capabilities and a method of indication are based on parameters of the DPS mode or a type of the first STA.

4. The method of claim 3, wherein the indication of reduced capabilities comprises an indication of a reduced channel width included in an operating mode notification frame or operating mode element, operation elements, or capabilities elements, corresponding to one or more Wi-Fi generations, transmitted in a frame by the AP.

5. The method of claim 3, wherein the indication of reduced capabilities comprises an indication of a reduced number of spatial streams (NSS) included in an operating mode notification frame or operating mode element, operation elements, or capabilities elements, corresponding to one or more Wi-Fi generations, transmitted in a frame by the AP.

6. The method of claim 3, wherein the indication of reduced capabilities comprises an indication of a reduced modulation and coding scheme (MCS) included in an operating mode element, an operating mode notification frame, operation elements, or capabilities elements.

7. The method of claim 3, wherein the reduced capabilities comprises one or more of a reduced channel width, a reduced number of spatial streams (NSS), a reduced modulation and coding scheme (MCS) or a reduced physical protocol data unit (PPDU) supported by the AP, which are indicated by exclusion of operation elements, or capabilities elements corresponding to one or more Wi-Fi generations in a frame transmitted by the AP.

8. The method of claim 3, further comprising communicating with the first STA based on the reduced capabilities that were indicated to the first STA before enabling the DPS mode.

9. The method of claim 3, further comprising:
receiving, from a second STA not associated with the AP, a probe request that complies with the reduced capabilities indicated to the first STA; and
transmitting a probe response to the second STA.

10. The method of claim 3, further comprising:
disabling the DPS mode; and
during disablement of the DPS mode, maintaining association with the first STA while transitioning from the low power state to the high power state by providing an indication of enhanced capabilities to the first STA after disabling the DPS mode, wherein the enhanced capabilities are based on the parameters of the DPS mode or the type of the first STA.

11. An access point (AP) comprising:
a transceiver; and
a processor operably coupled with the transceiver, the processor configured to:
determine a compatibility of a first station (STA) associated with the AP for a dynamic power save (DPS) mode; and
perform an enablement operation associated with enablement of the DPS mode based on the determined compatibility of the first STA for the DPS mode.

12. The AP of claim 11, wherein to perform the enablement operation, the processor is further configured to not enable the DPS mode when the determined compatibility of the first STA is incompatible with the DPS mode.

13. The AP of claim 11, wherein to perform the enablement operation, the processor is further configured to:
enable the DPS mode when the determined compatibility of the first STA is incompatible with the DPS mode; and
during enablement of the DPS mode when the determined compatibility of the first STA is incompatible with the DPS mode, maintain association with the first STA while transitioning from a high power state to a low power state by providing an indication of reduced capabilities to the first STA before enabling the DPS mode, wherein the reduced capabilities and a method of indication are based on parameters of the DPS mode or a type of the first STA.

14. The AP of claim 13, wherein the indication of reduced capabilities comprises an indication of a reduced channel width included in an operating mode notification frame or operating mode element, operation elements, or capabilities elements, corresponding to one or more Wi-Fi generations, transmitted in a frame by the AP.

15. The AP of claim 13, wherein the indication of reduced capabilities comprises an indication of a reduced number of spatial streams (NSS) included in an operating mode notification frame or operating mode element, operation elements, or capabilities elements, corresponding to one or more Wi-Fi generations, transmitted in a frame by the AP.

16. The AP of claim 13, wherein the indication of reduced capabilities comprises an indication of a reduced modulation and coding scheme (MCS) included in an operating mode element, an operating mode notification frame, operation elements, or capabilities elements.

17. The AP of claim 13, wherein the reduced capabilities comprises one or more of a reduced channel width, a reduced number of spatial streams (NSS), a reduced modulation and coding scheme (MCS) or a reduced physical protocol data unit (PPDU) supported by the AP, which are indicated by exclusion of operation elements, or capabilities elements corresponding to one or more Wi-Fi generations in a frame transmitted by the AP.

18. The AP of claim 13, wherein the processor is further configured to communicate with the first STA based on the reduced capabilities that were indicated to the first STA before enabling the DPS mode.

19. The AP of claim 13, wherein the processor is further configured to:
receive, via the transceiver from a second STA not associated with the AP, a probe request that complies with the reduced capabilities indicated to the first STA; and
transmit, via the transceiver, a probe response to the second STA.

20. The AP of claim 13, wherein the processor is further configured to:
disable the DPS mode; and
during disablement of the DPS mode, maintain association with the first STA while transitioning from the low power state to the high power state by providing an indication of enhanced capabilities to the first STA after disabling the DPS mode, wherein the enhanced capabilities are based on the parameters of the DPS mode or the type of the first STA.
